(19) United States
(12) Patent Application Publication
(10) Pub. No.: US 2015/0241349 A1
(43) Pub. Date: Aug. 27, 2015

(54) Engineering Bright Sub-10-nm Upconverting Nanocrystals for Single-Molecule Imaging

(71) Applicants: Bruce E. Cohen, San Francisco, CA (US); James P. Schuck, Oakland, CA (US); Daniel J. Gargas, Berkeley, CA (US); Emory M. Chan, Oakland, CA (US); Alexis D. Ostrowski, Maumee, OH (US); Jeffrey J. Urban, Emeryville, CA (US); Delia J. Milliron, Oakland, CA (US)

(72) Inventors: Bruce E. Cohen, San Francisco, CA (US); James P. Schuck, Oakland, CA (US); Daniel J. Gargas, Berkeley, CA (US); Emory M. Chan, Oakland, CA (US); Alexis D. Ostrowski, Maumee, OH (US); Jeffrey J. Urban, Emeryville, CA (US); Delia J. Milliron, Oakland, CA (US)

(73) Assignee: The Regents of the University of California, Oakland, CA (US)

(21) Appl. No.: 14/620,644

(22) Filed: Feb. 12, 2015

Related U.S. Application Data
(60) Provisional application No. 61/939,631, filed on Feb. 13, 2014.

(51) Int. Cl. G01N 21/64; C09K 11/77

(52) U.S. Cl. CPC G01N 21/64; C09K 11/7773; G01N 2201/06113

(57) ABSTRACT

Various embodiments of the invention describe the synthesis of upconverting nanoparticles (UCNPs), lanthanide-doped hexagonal β-phase sodium yttrium fluoride NaYF₄:Er³⁺/Yb³ nanocrystals, less than 10 nanometers in diameter that are over an order of magnitude brighter under single-particle imaging conditions than existing compositions, allowing visualization of single UCNPs as small (d=4.8 nm) as fluorescent proteins. We use Advanced single-particle characterization and theoretical modeling is demonstrated to find that surface effects become critical at diameters under 20 nm, and that the fluences used in single-molecule imaging change the dominant determinants of nanocrystal brightness. These results demonstrate that factors known to increase brightness in bulk experiments lose importance at higher excitation powers, and that, paradoxically, the brightest probes under single-molecule excitation are barely luminescent at the ensemble level.

### CROSS REFERENCE TO RELATED APPLICATIONS

This U.S. application claims priority to U.S. Provisional Application Ser. No. 61/939,631 filed Feb. 13, 2014, which application is incorporated herein by reference as if fully set forth in their entirety.

### STATEMENT OF GOVERNMENTAL SUPPORT

The invention described and claimed herein was made in part utilizing funds supplied by the U.S. Department of Energy under Contract No. DE-AC02-05CH11231 between the U.S. Department of Energy and the Regents of the University of California for the management and operation of the Lawrence Berkeley National Laboratory. The government has certain rights in this invention.

### BACKGROUND OF THE INVENTION

1. Field of the Invention

The present invention relates to the field of Lanthanide-doped upconverting nanoparticles (UCNPs).

2. Related Art

Nanocrystals that have unusual or exceptional optical properties have shown promise as transformative probes for biological imaging A key requirement for use in bioimaging is that the nanocrystals be biocompatible, and for many experiments this means that they need to be comparable in size to the biomolecules that they intend to label, so as not to interfere with cellular systems. Lanthanide-doped upconverting nanoparticles (UCNPs) are especially promising probes for single-particle tracking. However, the synthesis of sub-10-nm β-NaYF₄, the crystal structure that hosts the most efficient upconversion, has not yet been reported, and questions remain about whether small β-Phase sodium yttrium fluorides (β-NaYF₄) nanocrystals would retain the exceptional optical properties exhibited by larger UCNPs.

Imaging at the single-molecule level reveals heterogeneities that are lost in ensemble imaging experiments, but an ongoing challenge is the development of luminescent probes with the photostability, brightness, and continuous emission necessary for single-molecule microscopy. Lanthanide-doped upconverting nanoparticles (UCNPs) overcome problems of photostability and continuous emission, and their upconverted emission can be excited with near-infrared light at powers orders of magnitude lower than those required for conventional multiphoton probes. But the brightness of UCNPs has been limited by open questions about energy transfer and relaxation within individual nanocrystals and unavoidable trade-offs between brightness and size. Here, we develop UCNPs under 10 nm in diameter that are over an order of magnitude brighter under single-particle imaging conditions than existing compositions, allowing us to visualize single UCNPs as small (d=4.8 nm) as fluorescent proteins. We use advanced single-particle characterization and theoretical modeling to find that surface effects become critical at diameters under 20 nm, and that the fluences used in single-molecule imaging change the dominant determinants of nanocrystal brightness. These results demonstrate that factors known to increase brightness in bulk experiments lose importance at higher excitation powers, and that, paradoxically, the brightest probes under single-molecule excitation are barely luminescent at the ensemble level.

Lanthanide-doped upconverting nanoparticles (UCNPs) absorb multiple photons in the near infrared (NIR) and emit at higher energies in the NIR or visible (FIG. 1a), and have generated excitement because of significant advantages over other luminescent reporters. These include an absence of on-off blinking, single-molecule multiphoton NIR excitation at powers approaching those used for standard one-photon confocal imaging (FIG. 1b), no overlap with cellular autofluorescence, and no measurable photobleaching under prolonged single-particle excitation. Recent synthetic efforts have established control over UCNP size to produce smaller nanocrystals more compatible with many imaging applications, but this size reduction also significantly reduces brightness because surface losses increase in importance while the number of sensitizer and emitter ions per particle are reduced as r³. UCNPs make use of energy transfer upconversion (ETU), in which sensitizer ions with relatively large absorption cross-sections sequentially transfer absorbed energy to emitter ions that luminesce (FIG. 1a and FIG. 6). The most common upconverting nanocrystal composition is β-phase NaYF₄ doped with around about (ca.) or approximately 20% Ytterbium Yb³⁺ sensitizer and around about (ca.) or approximately 2% Erbium Er³⁺ emitter, NaYF₄:Er³⁺/Yb³⁺, concentrations which, in both bulk materials and nanocrystals, have been suggested to optimize brightness by increasing photon absorption and minimizing luminescence quenching.

Recent work on larger nanocrystals (d˜40 nm) has shown improvements in brightness with higher emitter concentrations at high excitation irradiance. The photophysical processes leading to luminescence quenching in larger nanocrystals and in the bulk are related primarily to cross-relaxation between dopants and energy migration to defects, but it is less clear how these kinetics are modified as nanocrystal sizes drop to single-digit diameters.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 illustrates luminescence of UCNPs.

FIG. 2 illustrates UCNP size-dependent luminescence intensity and heterogeneity.

FIG. 3 illustrates single UCNP luminescence lifetime as a function of particle size and excitation power.

FIG. 4 illustrates simulated UCNP emission intensity.

FIG. 5 illustrates luminescence intensity of single UCNPs as a function of Er³⁺ and Yb³⁺ doping.

FIG. 6 illustrates upconversion mechanisms in NaYF₄:Yb³⁺, Er³⁺ Nanocrystals.

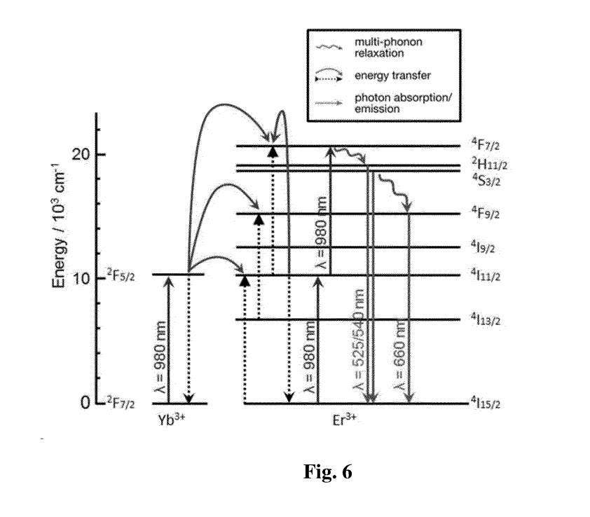

FIG. 7 illustrates experimental Setup for single UCNP optical characterization.

FIG. 8 illustrates data collection of single UCNP luminescence.

FIG. 9 illustrates single-UCNP luminescence spectra as a function of excitation intensity for four different particle sizes.

FIG. 10 illustrates analysis of single UCNP luminescence intensity.

FIG. 11 illustrates anti-bunching measurement on single particles.

FIG. 12 illustrates luminescent decay data from a 150 nm UCNP and subsequent fitting.

FIG. 13 illustrates a comparison of the major lifetime component values for green and red bands.

FIG. 14 illustrates single particle lifetime vs excitation power.

FIG. 15 illustrates luminescence decay curves vs nanocrystal diameter.

FIG. 16 illustrates single particle luminescence of core-shell UCNPs.

FIG. 17 illustrates single particle intensities for sub-10 nm UCNPs with various dopant compositions.

FIG. 18 illustrates representative mechanism output from simulations.

FIG. 19 illustrates steady-state manifold populations for Yb³⁺ and Er³⁺ from simulations of 8-nm UCNPs with 20% Er³⁺ and 2% Er³⁺.

FIG. 20 illustrates simulated luminescence intensity of 8-nm UCNPs with 20% (blue curve) and 2% (red curve) Er³⁺, each with 20% Yb³⁺, plotted as functions of excitation power.

FIG. 21 illustrates simulated luminescence intensity of UCNPs with 20% Yb³⁺ as a function of Er³⁺ doping and excitation power.

### DETAILED DESCRIPTION

In the discussions that follow, various process steps may or may not be described using certain types of manufacturing equipment, along with certain process parameters. It is to be appreciated that other types of equipment can be used, with different process parameters employed, and that some of the steps may be performed in other manufacturing equipment without departing from the scope of this invention. Furthermore, different process parameters or manufacturing equipment could be substituted for those described herein without departing from the scope of the invention.

These and other details and advantages of the present invention will become more fully apparent from the following description taken in conjunction with the accompanying drawings.

Various embodiments of the invention describe the synthesis of upconverting nanoparticles (UCNPs) NaYF₄:Er³⁺/Yb³⁺ under 10 nm in diameter that are over an order of magnitude brighter under single-particle imaging conditions than existing compositions, allowing us to visualize single UCNPs as small (d=4.8 nm) as fluorescent proteins. We use advanced single-particle characterization and theoretical modeling to find that surface effects become critical at diameters under 20 nm, and that the fluences used in single-molecule imaging change the dominant determinants of nanocrystal brightness. These results demonstrate that factors known to increase brightness in bulk experiments lose importance at higher excitation powers, and that, paradoxically, the brightest probes under single-molecule excitation are barely luminescent at the ensemble level.

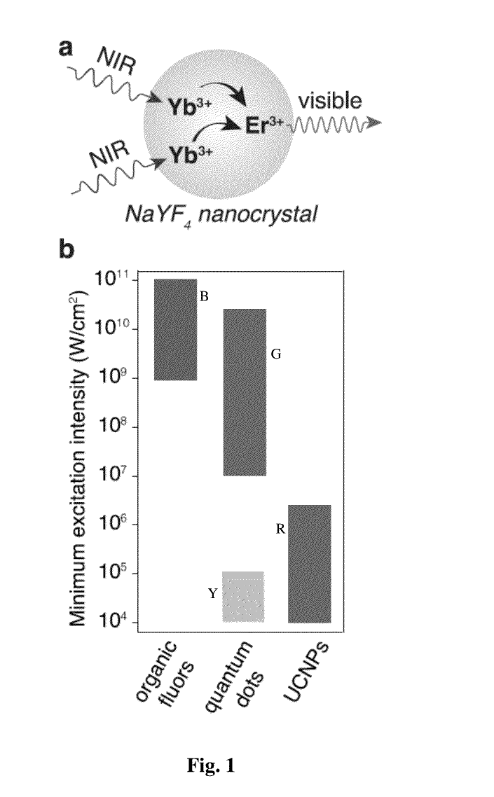

FIG. 1 illustrates luminescence of NaYF₄:Er³⁺/Yb³⁺ UCNPs. FIG. 1a, Schematic of energy transfer upconversion with Yb³⁺ as a sensitizer and Er³⁺ as an emitter. FIG. 1b, Minimum peak intensities of NIR light needed for multiphoton single-molecule imaging of various classes of luminescent probes. The peak intensity ranges shown are required to detect signals of ˜100 c.p.s. for core-shell quantum dots (G), 40 nm colloidal double dot-rods (Y), organic fluorophores (B) and UCNPs (R).

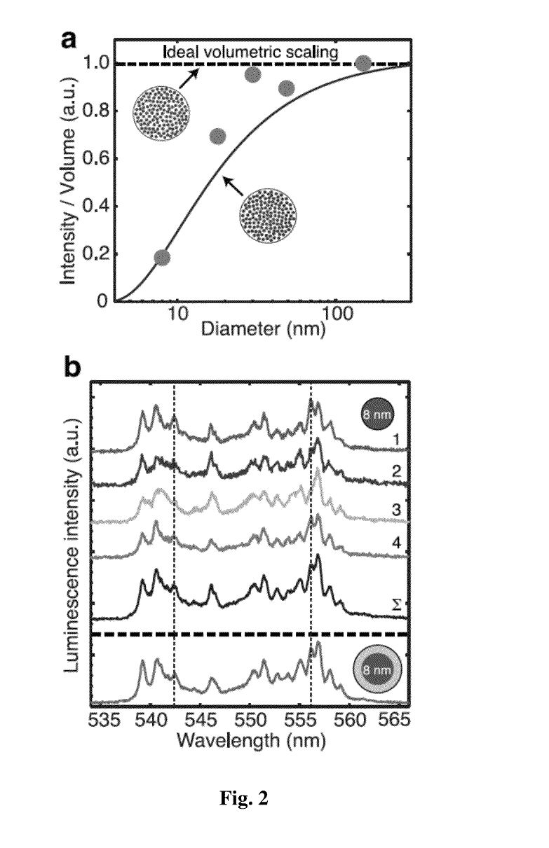

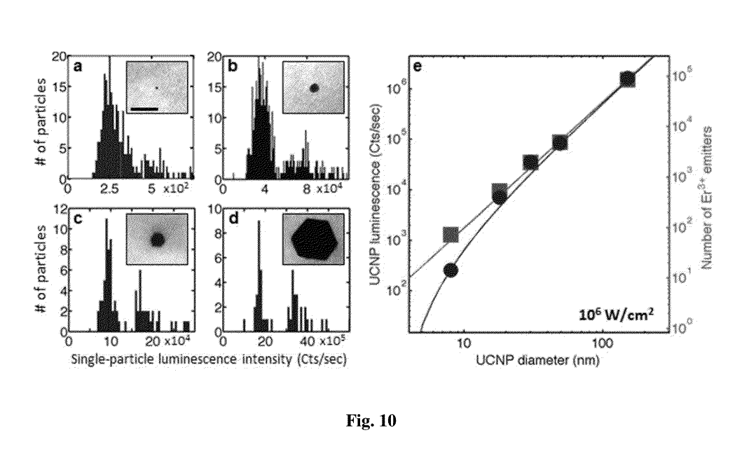

To understand the efficiency of the ETU process in these UCNPs and potential sources of energy loss associated with the nanocrystal surface, we investigated size-dependent luminescence intensity distributions of single UCNPs (FIG. 2 and FIGS. 7-10). Even under the dilute conditions used to prepare samples for single nanocrystal measurements, we note the presence in SEM images of a small fraction of dimers and other aggregates (FIG. 10).

FIG. 2 illustrates UCNP size-dependent luminescence intensity and heterogeneity. FIG. 2a, deviation of single UCNP luminescence intensity normalized to particle volume (n=300 total) from ideal volumetric scaling. The curve represents calculated intensity normalized to volume for UCNPs with a nonluminescent surface layer of 1.7 nm. Only intensities from single, unaggregated nanocrystals, as determined by FIG. 10, are used. FIG. 2b, fine spectra of the green emission bands collected from four single 8 nm UCNPs and their averaged spectra. Vertical dotted lines highlight peaks exhibiting heterogeneity between individual UCNPs. The green emission spectrum of an 8 nm UCNP with epitaxial 1.8 nm undoped shell is shown below the horizontal dashed line.

In FIG. 2 and throughout this discussion, we use emission only from single, non-aggregated nanocrystals, which is critical to understand size- and surface-dependent UCNP photophysics, and which may be compromised in ensemble measurements. For larger UCNPs (d>20 nm), emission intensity scales linearly with particle volume, but at smaller sizes, surface-related losses become significant, reducing brightness below that predicted for ideal volumetric scaling (FIG. 2a). This trend is consistent with the recent ensemble measurements on sub-10-nm UCNPs, and these data can be analyzed using a simple calculation, in which the UCNP is divided into two regions: a dark surface region and a luminescent core region. In the context of this calculation, our data indicate the dark surface radius is ˜1.7 nm, since the observed intensity of the 8-nm particles is equivalent to the extrapolated intensity of a ˜4.6 nm-diameter particle assuming ideal volumetric scaling.

We believe that the “dark” region of the nanocrystal—the outermost 1.7 nm of a nanocrystal—contains dopants whose excited states decay rapidly due to energy transfer to ligand vibrational modes or surface phonons. There are two well-established ways that this vibrational coupling can occur: (1) direct coupling of dopant states to vibrational modes, and (2) resonant, energy migration from one excited dopant to a dopant that is directly coupled to a surface vibrational mode.

One hypothesis is that the 1.7 nm could represent the critical length scale for direct coupling of energy transfer from a dopant to a surface mode. This length scale is reasonable considering that soluble lanthanide complexes can be quenched by the vibrations of their ligands' many C—H bonds at distances of up to 3 nm.

Alternatively, the 1.7 nm distance could represent an effective “diffusion” length, the average distance over which energy migrates via random donor-to-donor energy transfer before the excited state relaxes, radiatively or non-radiatively. If an excited dopant is <1.7 nm from the surface, then it is more likely to transfer its energy non-radiatively to a surface state than to undergo other processes. Dopants >1.7 nm from the surface would still be coupled to the surface, but the likelihood of transferring their energy to the surface would be less.

We believe that the 1.7 nm distance is most likely a convolution of the distance for direct energy transfer and the effective diffusion length for energy migration. More detailed measurements would have to be performed in order to gain more fine-grained insight into this distance, but in the context of our work, this initial measurement was still valuable for guiding our development of brighter dopant compositions for upconversion.

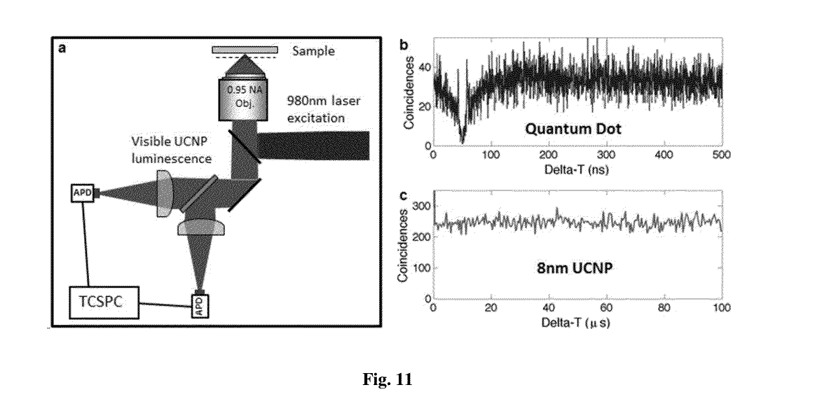

To understand the origins of these surface-related losses, we collected visible emission spectra from ˜40 individual 8-nm UCNPs. Unlike homogeneous room-temperature spectra of larger UCNPs, these high-resolution spectra are heterogeneous, with particle-to-particle variations in peak intensities at 541 and 557 nm (FIG. 2b; compare curves 1 & 4 with curves 2 & 3). One explanation for such heterogeneity would be that emission from these UCNPs is dominated by only a few of the around about (ca.) 70 Er³⁺ emitters present in each UCNP, but this is not supported by photon antibunching studies of single UCNPs (FIG. 11). Addition of undoped NaYF₄ shells to these nanocrystals eliminates this heterogeneity (FIG. 2b, bottom trace) suggesting a region within the nanocrystal in which the lanthanides may be emissive but are energetically coupled to the surface. The observed spectral differences may arise from either variations in lanthanide distributions between nanocrystals, or from subtle variations in surface defects, surface reconstruction, or faceting. This identification of losses from energy transfer to the surface suggests one means for improving emission from small UCNPs.

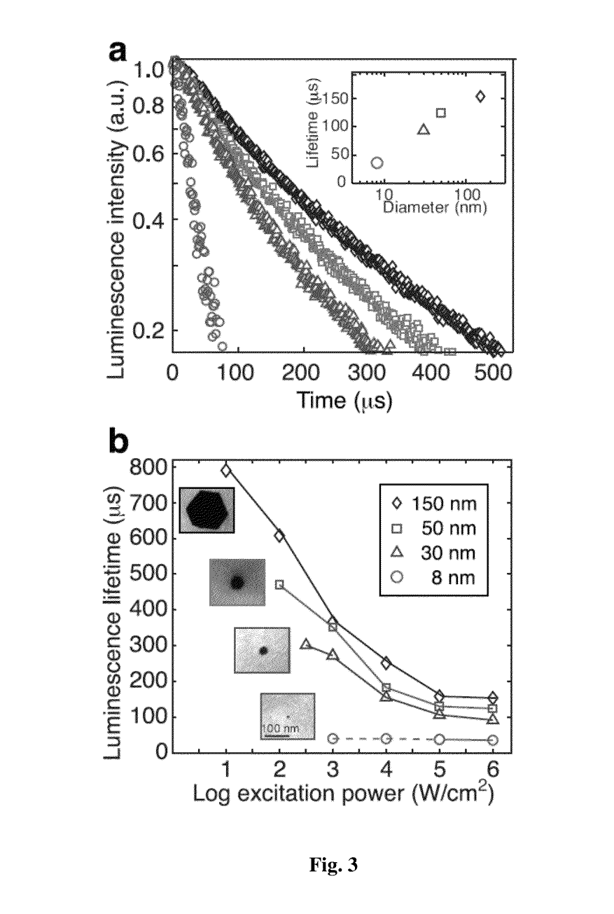

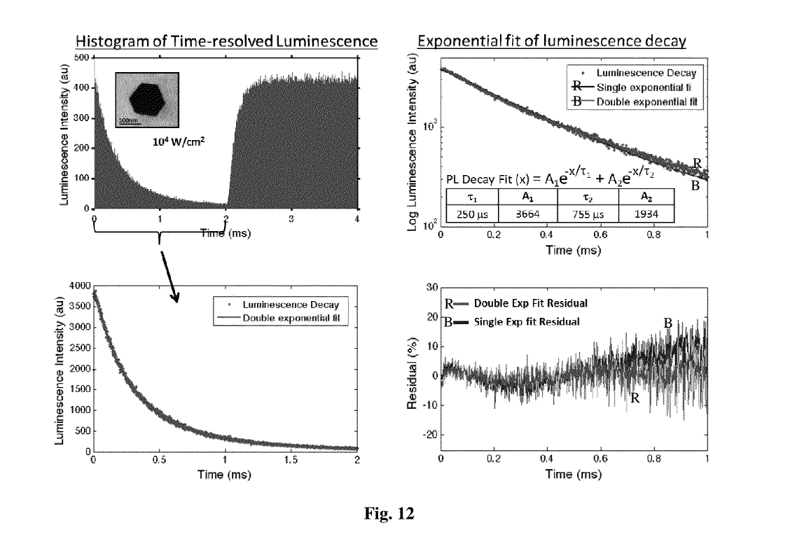

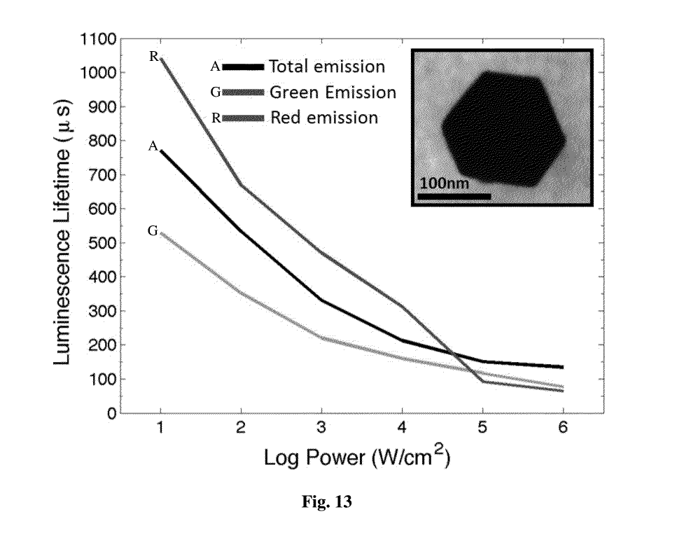

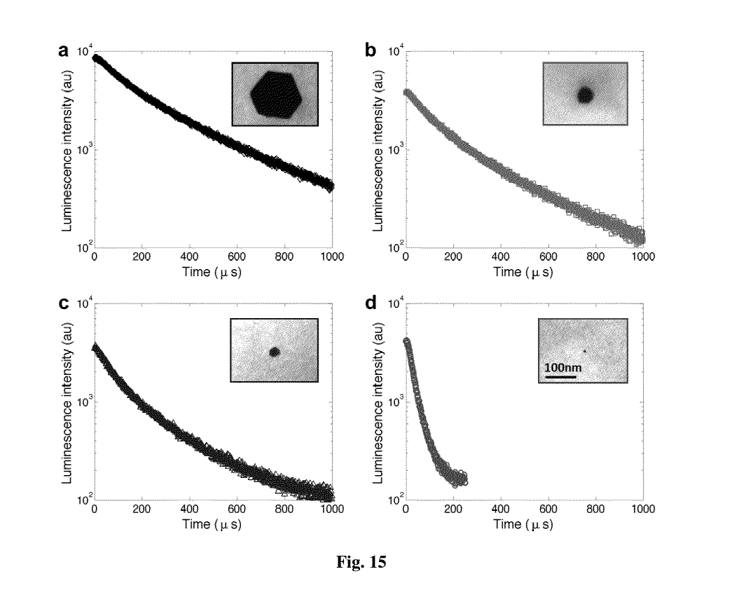

FIG. 3 illustrates single UCNP luminescence lifetime as a function of particle size and excitation power. FIG. 3a, luminescence decay (normalized) plotted for various UCNP diameters. (See FIG. 15 for full lifetime curves.) Inset: lifetime values plotted as a function of UCNP diameter. Lifetime values were determined by fitting luminescence decay curves to a double exponential and plotting only the dominant decay value. FIG. 3b, Single UCNP lifetime values for various diameters plotted as a function of excitation power. In these plots, emission from all wavelengths between 532 nm and 700 nm was used for the fit because the trends were the same for all emission bands in this range. Separate fits for just green and red emission were also collected and are discussed in FIGS. 12 and 13 and Table 1. For simplicity, only dominant lifetime decay values are plotted. Dashed line represents data collected from 8 nm UCNP clusters.

TABLE 1
Lifetime Values and Coefficients vs. UCNP Size:
Red Band, Green Band, and Combined Luminescence

| | | | | |
|---|---|---|---|---|
| 10⁴ W/cm² | τ₁ | A₁ | τ₂ | A₂ |

Collected Wavelengths = 532 nm − 700 nm

| | | | | |
|---|---|---|---|---|
| 150 nm | 250 μs | 0.65 | 755 μs | 0.35 |
| 50 nm | 182 μs | 0.60 | 486 μs | 0.40 |
| 18 nm | 158 μs | 0.92 | 805 μs | 0.08 |

Collected Wavelengths = 540 nm ± 20 nm

| | | | | |
|---|---|---|---|---|
| 150 nm | 160 μs | 0.61 | 529 μs | 0.39 |
| 50 nm | 140 μs | 0.61 | 425 μs | 0.39 |
| 18 nm | 144 μs | 0.93 | 838 μs | 0.07 |

Collected Wavelengths = 650 nm ± 20 nm

| | | | | |
|---|---|---|---|---|
| 150 nm | 312 μs | 0.76 | 1061 μs | 0.24 |
| 50 nm | 252 μs | 0.69 | 697 μs | 0.31 |
| 18 nm | 174 μs | 0.95 | 1056 μs | 0.05 |

Table 1 illustrates lifetime values and their corresponding coefficient values for bi-exponential fits to “all” wavelength range (532 nm-700 nm) luminescence (top section), green band (540±20 nm) luminescence (middle section), red band (650±20 nm) luminescence (bottom section) from single UCNPs of different sizes. The excitation intensity was 10⁴ W/cm² for this data

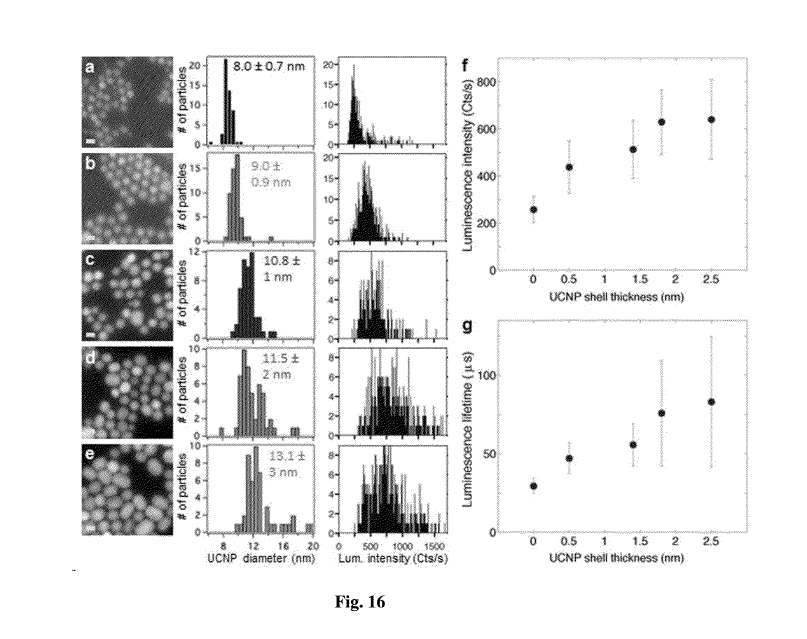

We then measured luminescence lifetimes of individual UCNPs of various sizes to probe the balance between energy transfer pathways that lead to radiative and nonradiative relaxation. As UCNP size decreases, fast, and presumably nonradiative, recombination dominates (FIG. 3a). To determine whether surfaces are a primary source of the nonradiative relaxation, we measured lifetimes of 8-nm UCNP cores with added undoped NaYF₄ shells. Emission intensities and lifetimes both increase as shell thickness increases, up to a shell thickness of ˜1.8 nm (FIG. 16), suggesting that the increased luminescence is due to improved quantum yields for core/shell nanocrystals. This saturation of lifetime and brightness at a shell thickness of ˜1.8 nm is consistent with the model (FIG. 2a) that the emitters within this surface radius are quenched by energy transfer to vibrational modes at the nanocrystal surface or in organic capping ligands. Since dopant excited states can be coupled to surface vibrations directly or via resonant, donor-to-donor energy migration to directly coupled states, this ˜1.8 nm distance can be interpreted physically as a convolution of the critical distance for direct coupling and the average energy migration length (See discussion on the origins of the 1.7 nm dark surface region above). Critically, for UCNPs with d<8 nm, this dark surface layer occupies a large majority (>80%) of total nanocrystal volume.

Previous work has shown that UCNP lifetimes are roughly independent of excitation power for powers <100 W/cm², but the low power densities used in those experiments are not useful for imaging small, single UCNPs. At higher single-nanocrystal powers, we observe a pronounced lifetime dependence on excitation power density for all UCNPs with d>30 nm (FIG. 3b). We considered the possibility that these higher powers may generate enough heat to significantly affect lifetimes, though we observed no change in lifetime for any UCNPs as pump pulse widths were increased from 250 μs to 2.5 ms, indicating that the particles reach a steady state temperature in less than 250 μs. Rather, the lifetime dependence on excitation power suggests that the higher fluences increase the spatial density of populated Er³⁺ excited states with longer lifetimes (such as ⁴S_{3/2}), increasing rates of the energy transfer upconversion and cross relaxation out of these states. This leads to shorter lifetimes for states that emit visible photons and increases the population of higher-energy excited states (such as ⁴G_{11/2}). However, for the sub-10-nm UCNPs, the luminescence lifetime is short and remains constant for all excitation powers studied here (FIG. 3b), owing to the dominance of surface-related nonradiative recombination in UCNPs of this size. This suggests that the entire 8-nm particle is energetically coupled to the surface—though the nanocrystal radius is larger than the dark radius of 1.7 nm—and is consistent with the presence of the sub-surface region containing emissive lanthanides that are nonetheless influenced by the surface.

Surface-related nonradiative recombination greatly shortens the lifetime of excited emitters, which suggests an opportunity in that emitter concentrations could be increased substantially beyond 2% before self-quenching becomes a major factor. In this case, the surface energy losses change the relative balance between energy transfer pathways in smaller UCNPs. In addition, the higher fluences of single-molecule imaging push the nanocrystals into the excitation saturation regime and further modify the balance of energy transfer between states. These findings suggest that optimal design has not yet been achieved for sub-10-nm UCNPs intended for single-molecule applications, where the goal is to maximize emission over background and noise levels.

We used these observations to refine computational models of UCNP energy transfer to design UCNPs that are brighter under single-molecule imaging conditions. Emission intensity was calculated as a function of Er³⁺ and Yb³⁺ dopant concentrations using a population balance model that has successfully predicted the steady-state luminescence spectra of various lanthanide-doped UCNPs. Based on the single-nanocrystal intensity and lifetime data, we modified this model to include a third, non-emissive surface species that can accept energy from excited lanthanide states.

TABLE 2
General simulation parameters

| Parameter | Value |
|---|---|
| Simulation time period (ms) | 3 |
| Phonon energy (cm⁻¹)⁵ | 450 |
| W⁰_{MPR}, zero-phonon relaxation rate(s⁻¹)^{3, 4} | 1 · 10⁷ |
| α, MPR rate constant(cm)⁴ | 3.5 · 10⁻³ |
| Index of refraction (β-NaYF₄) | 1.5 |
| Volume per potential dopant site (nm³)* | 7.2395 · 10⁻² |
| Minimum dopant distance, β-NaYF₄ (nm)* | 0.3867 |
| Absorption fwhm (cm⁻¹) | 400 |
| Incident excitation wavelength (nm) | 978 |

(*Calculated from crystal structure of β-NaYF₄ (JCPDS# 16-0334))

Kinetic simulations were performed according to the method previously reported by our team using Igor Pro 6.3 (Wavemetrics). N ordinary differential equations, which represent the population of each of the N manifolds in the simulated system, were solved numerically using the Igor Pro's Backwards Differentiation Formula integration method. All ions (i.e., Er³⁺ and Yb³⁺) were placed in their ground states at the start of the simulation. Time steps for iterations were determined dynamically by the integration algorithm, and all simulated systems reached steady state by the end of the simulation time period. Lifetimes were simulated by performing a second simulation in which the excitation power density was set to zero, and initial manifold populations were set to the steady state populations of the previous simulation.

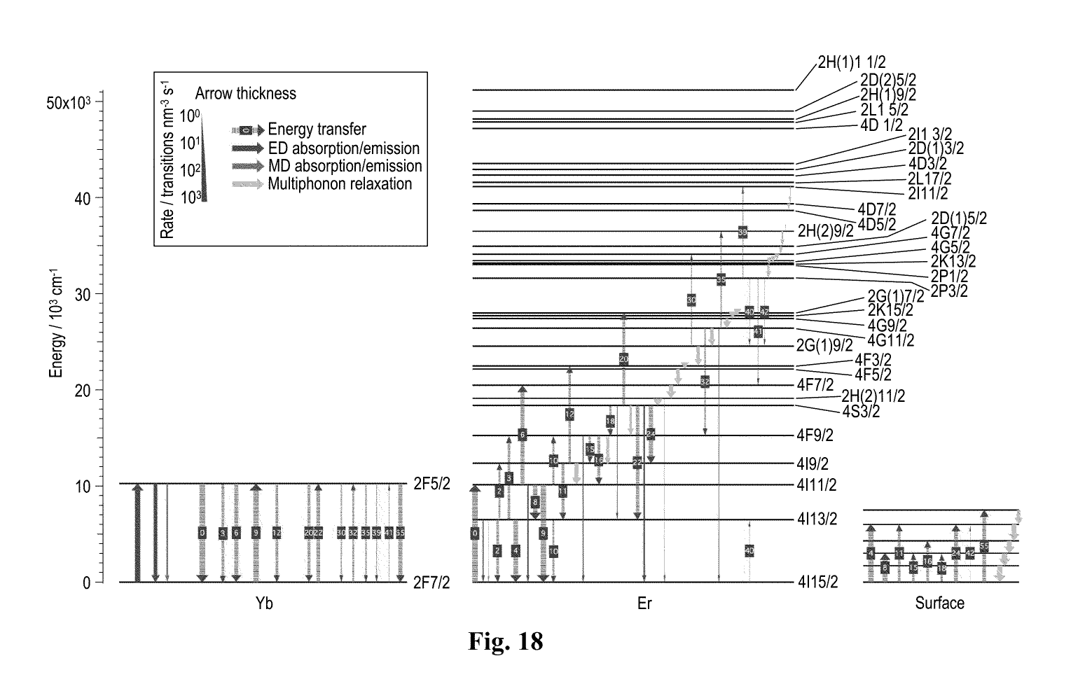

These simulations calculate and utilize the rates of all possible transitions, even those far from resonance. Since the radiative electric dipole transitions are calculated using Judd-Ofelt theory, all absorption transitions, even excited state absorption, are considered (see FIG. 18 for representative output given in the form of an energy level diagram). In other words, for all initial and final states, i and f, the model incorporates the transition rates for all combinations of i and f, for all species. Likewise, all energy transfer (ET) processes are considered by the model—all ET processes with rates above a given threshold are incorporated into the differential equations to be solved. Therefore, back transfer is incorporated as simply another energy transfer process (FIG. 18).

Simulation of surface species. To simulate the effect of non-radiative surface quenching sites in nanocrystals, we introduced a third species into our model (in addition to Er³⁺ and Yb³⁺), which we refer to as the “surface species.” To simulate the vibrational modes of surface ligands and other processes that could non-radiatively relax the excited states of lanthanide ions near the surface of the nanocrystals, the surface species were given excited states with energies that correspond to vibrational modes of bonds found in typical organic ligands (FIG. 18): 1700 cm⁻¹ (C═O stretch), 3000 cm⁻¹ (C—H, O—H stretches), 4300 cm⁻¹ (C—C+C—H combinations), and 6000 cm⁻¹ (C—H, 1^{st} overtone), and 7500 cm⁻¹ (C—H, 2^{nd} overtone; C—H combinations, 2^{nd} overtone). This collection of discrete resonances, while clearly not exhaustive, covers a sufficient energy range to mimic the most common energy transfer pathways from lanthanide ions to ligands.

Because the surface species are treated identically to lanthanide species in the simulations, the energy transfer is dependent on the line strengths S of ground state absorption transitions to the surface species' excited states. For all ground state transitions, we estimated S values of 5·10⁻²¹ cm² based on typical integrated molar absorptivities of organic molecules of 100-50,000 M⁻¹cm⁻² (see, for example, sodium oleate at ˜3000 cm⁻¹). The S values for excited state-to-excited state transitions were set to zero. Surface species that accept energy from lanthanide species rapidly relax in energy via non-radiative pathways. In our model, this non-radiative decay is treated for convenience as “multi-phonon relaxation” through the ladder of excited states belonging to the simulated surface species.

Because resonant donor-to-donor energy migration enables rapid energy transfer across large distances in highly doped materials—as is the case for all materials discussed in the application, energy transfer rates are determined by the minimum distance allowed between two species in the crystal structure, rather than the average or actual distances between species. Thus, it was not necessary for our model to distinguish between lanthanide ions adjacent to surface states and those far away, since donor states far from the surface can effectively transmit their energy between dopants in the middle. Ultimately, our refined model accounted for the size of nanoparticles by varying the concentration of the “surface” states according to the surface-area-to-volume ratio of the nanocrystals.

Calculations for 8 nm-diameter particles: Assuming a surface defect state for every ligand on the surface of a nanoparticle, we can use an approximate value of one ligand or surface state per nm² surface area. For an 8-nm particle with surface area SA=201 nm² and volume V=268 nm³ there would be 0.75 surface states/nm³. We have 13.8 dopant sites/nm³, so 0.75/13.8=0.054 surface species per available dopant site in a NaYF₄ nanocrystal, or effectively 5 mol % of surface species in the nanocrystal.

Likewise, for a 5 nm-diameter nanocrystal, the surface area is 19.6 nm² and the volume is 16.5 nm³, or 19.6/16.5=1.2 surface species/nm³=8.6 mol % surface species.

Yb³⁺. Since Yb³⁺ only has one excited state manifold, Judd-Ofelt parameters cannot be determined empirically from absorption spectra. However, the absorption cross section of Yb³⁺ in various fluoride matrices at the incident excitation wavelength (978 nm) has been reported by several sources to be in the range of 1-2·10⁻²⁰ cm², which agrees with the common observation that the absorption cross section of Yb³⁺ is an order of magnitude greater than that of the Er^{3+ 4}I_{15/2}→⁴I_{11/2} transition. With a peak width (fwhm) of ˜400 cm⁻¹, the integrated cross section of the Yb^{3+ 2}F_{7/2}→²F_{5/2} transition is ˜5·10⁻¹⁸ cm, resulting in an electric dipole line strength, S_{ED}, of approximately 3·10⁻²° cm².

Er³⁺. For simulations, the 34 lowest Er³⁺ manifolds (up to 51,200 cm⁻¹) were used.

TABLE 3
Judd-Ofelt parameters and reduced matrix
elements used for simulations.

| Parameter | Er³⁺ | Yb³⁺ |
|---|---|---|
| Ω₂ | 2.11 | N/A |
| Ω₄ | 1.37 | |
| Ω₆ (10⁻²⁰ cm²) | 1.22 | |
| S_{ED} Electric dipole Line strength (cm²) | | 3 · 10⁻²⁰ |
| Source, Ω_{λ} | Experimental | |
| Source, \|<i\|U^{λ}\|j>\|² | Kaminski et al. | |

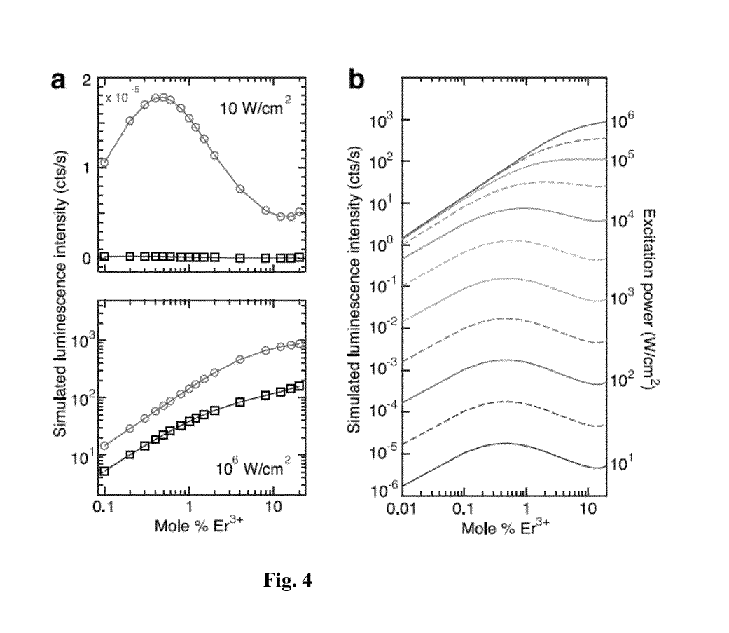

FIG. 4 illustrates simulated UCNP emission intensity. FIG. 4a, theoretical models of integrated 8 nm UCNP emission (500-700 nm) as a function of Er³⁺ mol % for 20% Yb³⁺ (circles) and 2% Yb (squares) for low (10 W cm⁻², upper panel) and high (106 W cm⁻², lower panel) power excitation. Fig. b, simulated luminescence intensity of UCNPs with 20% Yb³⁺ as a function of Er³⁺ doping and excitation power. Solid lines are calculated UCNP emission following excitation at powers on the right axis. Dashed lines are half logarithmic spacings.

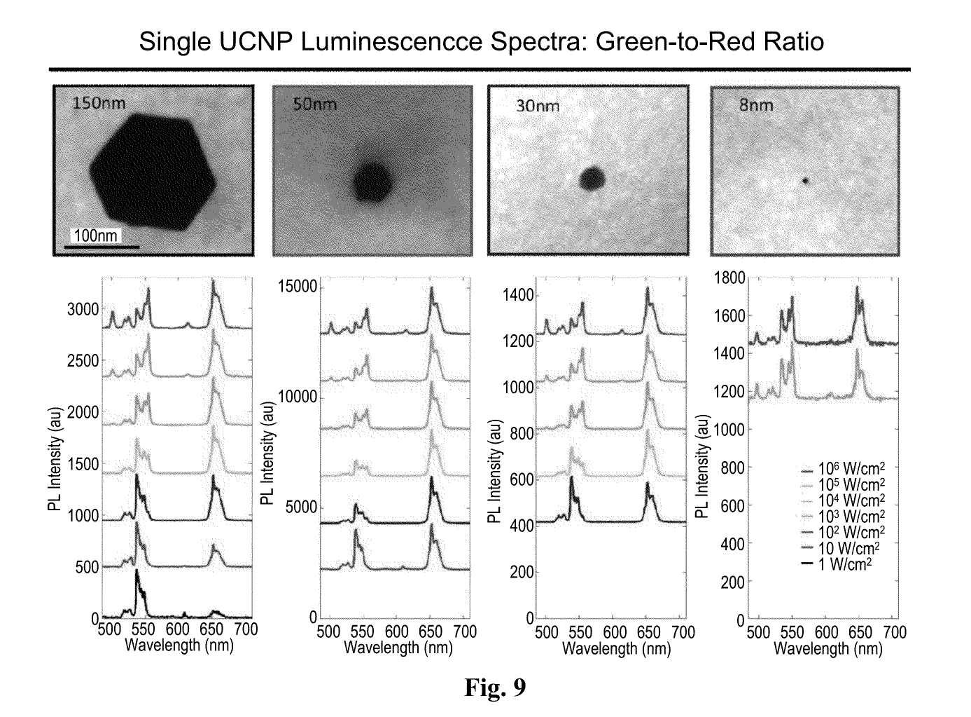

At the low excitation powers typical of ensemble measurements (10 W/cm²), the simulated emission intensity is maximized at ca. 0.5% Er³⁺ (FIG. 4a, top)—close to the 1-2% Er³⁺maximum typically observed for Er³⁺-containing nanocrystals. On the other hand, increasing the Yb³⁺ concentration from 2 to 20% increases the luminescence by two orders of magnitude at all Er³⁺ concentrations. However, when we apply the refined model to the higher powers (10⁵-10⁷ W/cm²) needed to observe single small nanocrystals, we find that the sensitizer Yb^{3+ 2}F_{5/2} excited manifold has its population approach 70% of the overall Yb³⁺ ion concentration, well into the saturation regime (see FIG. 9). At these higher fluences, the incremental Yb³⁺ absorption cross-section decreases significantly, thereby resulting in a reduced dependence of emission on Yb³⁺ sensitizer concentration (FIG. 4a, bottom). The number of Er³⁺ emitters becomes the fundamental bottleneck for visible emission because radiative relaxation rates for parity-forbidden 4f*4f transitions are significantly slower than photon absorption rates in this regime. See FIG. 4b and discussion below on the origins of the rate limiting steps in Yb³⁺/Er³⁺-doped UCNPs at high excitation fluences. Luminescence increases linearly as a function of Er³⁺ doping percentage (FIG. 4b), because the emission intensity is proportional to the number of Er³⁺ states that can emit visible photons (e.g., ⁴S_{3/2}, ⁴F_{9/2})²⁸, as well as the number of Er³⁺ ions that can absorb incident photons. This model predicts that a UCNP with 20% Er³⁺ will be three- to five-fold brighter at higher excitation fluences than a conventional 2% Er³⁺ UCNP of the same size, and that Yb³⁺ doping levels are of lesser importance than at lower fluences.

We now discuss the origins of the rate limiting steps in Yb³⁺/Er³⁺-doped UCNPs at high excitation fluences. In a typical upconversion luminescence process, the following sequence of steps must occur:

Absorption of 980 nm photons by Yb³⁺

Energy transfer to Er³⁺

Multiphonon relaxation

Emission of a visible photon via radiative relaxation of an Er³⁺ state

The overall rate (−dNᵢ/dt) of each of these processes is the product (N_{I} A_{i→j}) of the population (Nᵢ) of the originating manifold(s) and the transition rate constant (A_{i→j}). Therefore, if one of these processes (e.g., absorption) is significantly slower than a subsequent step (e.g., energy transfer), that reduces the populations of the initial manifolds involved in the later steps, thereby reducing the rates of those steps. Thus, the slowest step is the rate-limiting step since the step determines the rate of the entire sequence.

FIG. 9 illustrates single-UCNP luminescence spectra as a function of 980 nm excitation intensity for 4 different particle sizes. Particle diameters are listed in the upper left corner of each scanning electron microscope image. For the smaller sizes, sufficient signal was obtained only for the higher excitation fluences. We observe a clear change in green-to-red luminescence intensity ratio as function of excitation power, as well as the emergence of higher excited state transitions (and excited state to excited state transitions; e.g. the ˜555 nm band). Data curves are shown vertically from highest power density 10⁶ W/cm² decreasing to lowest 10⁶ W/cm².

For ensemble upconversion measurements at low excitation power and low Er³⁺ concentration (e.g., 2%), photon absorption can be considered the bottleneck. Thus, researchers typically use high Yb³⁺ concentrations to increase the absorption rate and the rate of upconversion luminescence. However, at high excitation powers (e.g. 10⁶ W/cm²) and low Er³⁺ concentration, a significant fraction (68%) of Yb³⁺ ions are in their excited state (FIG. 9). This build-up of the intermediate Yb³⁺ excited state means that the rate limiting step is after the absorption process, since rapid relaxation of the Yb³⁺ excited state would keep its population very low. Analysis of simulation data shows that the ground state and first excited state of Er³⁺ are less than 10% occupied at steady state at high power. This reduced population limits the rate of energy transfer between an excited Yb³⁺ state these acceptor Er³⁺ states, since the rate is proportional to product of the donor and acceptor concentrations (N_{Er.acceptor}N_{Yb.donor}).

The reason why the Er³⁺ ground state is so underpopulated is that the processes that relax Er³⁺ excited states, radiatively or non-radiatively, back to the ground state are slow relative to the rate of creation of these excited states via absorption and Yb³⁺→Er³⁺ energy transfer. Rather than emitting photons, the excited states undergo repeated energy transfer upconversion to higher Er³⁺ excited states in the ultraviolet, which is not useful for visible imaging. Thus, the rate limiting step for upconverted luminescence at high excitation power is the radiative relaxation of Er³⁺.

Increasing the concentration of Er³⁺ increases upconverted luminescence at high excitation powers by increasing the population of Er³⁺ ground and excited states—thereby “widening” the bottleneck. Increasing the ground state Er³⁺ population increases the rate of energy transfer from Yb³⁺ to Er³⁺, while increasing the population the visible-photon-emitting Er³⁺ manifolds (²H_{11/2}, ⁴S_{3/2}, ⁴F_{9/2}) increases the rate of visible luminescence (e.g., N_{Er:4S3/2}A_{Er:4S3/2→Er:4I15/2}). Increasing the Er:Yb ratio also spreads out energy across more Er³⁺ ions, so that few ions are in ultraviolet-emitting states. Thus, at high excitation intensities, where absorption of photons is not rate-limiting, higher Er³⁺ concentrations lead to higher visible upconversion luminescence.

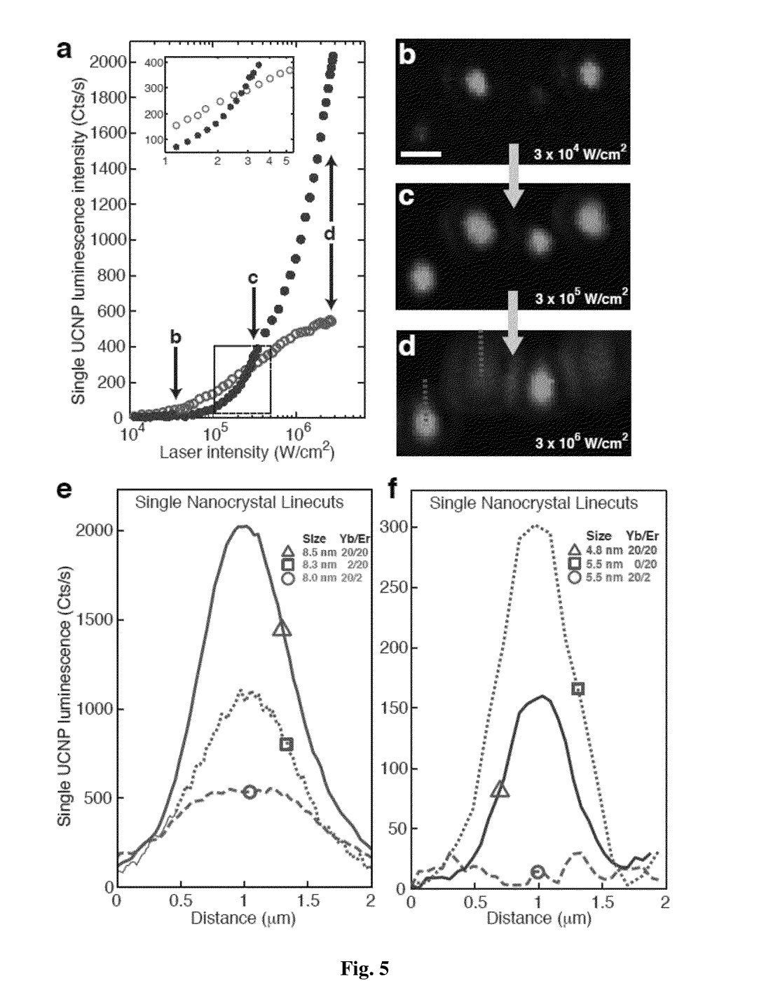

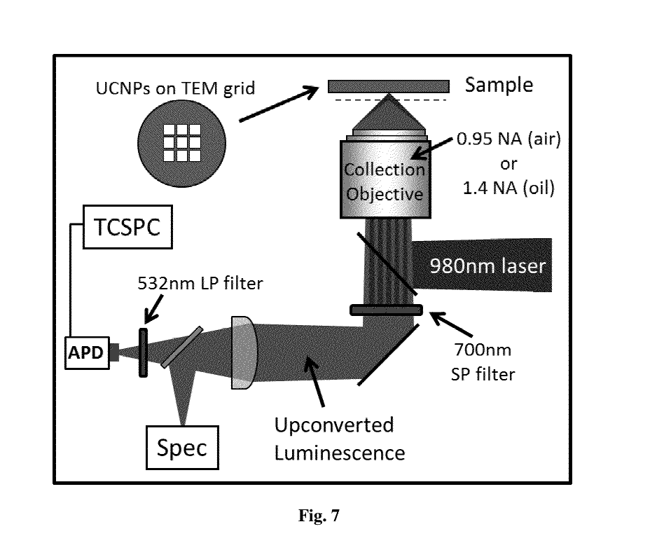

FIG. 5 illustrates luminescence intensity of single UCNPs as a function of Er³⁺ and Yb³⁺ doping. FIG. 5a, Luminescence intensity of single UCNPs with 20% (hollow circles) and 2% (solid dots) Er³⁺, each with 20% Yb³⁺, plotted as a function of excitation power. FIG. 5b-d, confocal luminescence images of a region containing single UCNPs in FIG. 5a, collected at increasing excitation powers. Dashed lines indicate regions from which luminescence intensity was collected for data in FIG. 5a. Scale bar, 1 mm FIG. 5e,f, linecuts of single-particle luminescence scans of ˜8 nm UCNPs and ˜5 nm UCNPs with varying Er³⁺ and Yb³⁺ doping levels. Size is diameter (nm) and Yb and Er levels are in atomic %. Emission from 5.5 nm UCNPs with 20% Yb³⁺ and 2% Er³⁺ are indistinguishable from our sensitivity limit determined by instrument noise. These data were collected using 3×10⁶ W cm⁻² excitation power and a ×100, 1.4 NA oil-immersion lens (see Methods and FIG. 7 for details).

Emission data in FIG. 5e-f are not normalized for minor variations in nanocrystal size, and we note that doing so would change some relative intensities. The size difference between the 5.5 nm-diameter 20% Er³⁺ nanoparticles and the 4.8 nm-diameter 20% Yb³⁺ 20% Er³⁺ nanoparticles is the reason for the greater intensity of the larger nanoparticles. After accounting for the 1.7-nm radius of optically inactive surface, the 4.8-nm UCNPs would have an optically active core diameter of 1.4 nm, while the 5.5 nm UCNPs would have 2.1 nm active core diameter. Normalizing for size differences, 5.5-nm particles should have ˜(2.1/1.4)³=3.4× greater upconversion luminescence intensity than 4.8 nm particles of the same composition. We therefore project that single, 5.5-nm 20% Yb³⁺ 20% Er³⁺ nanoparticles would have a peak intensity of ˜540 cts/sec, which is greater than the 300 cts/sec of the 20% Er³⁺ nanoparticles shown in the same plot. Thus, addition of 20% Yb³⁺ increases luminescence over Yb³⁺-free nanocrystals. Of course, the 20% Yb³⁺ 2% Er³⁺ UCNP peak remains at the baseline even when normalized. Given the smaller relative size variations for the 8-nm UNCPs in FIG. 5e, changes are much smaller and do not change relative intensities.

This points to a radically different design strategy for nanocrystals to be used for ensemble measurements versus those to be used for single molecule studies: for single-molecule studies, emitter concentrations should be as high as possible without compromising the structure of the nanocrystal, while sensitizer content becomes less significant at higher powers, and can potentially be eliminated for single-molecule imaging applications. Based on these calculations, we synthesized a series of 8-nm and 5-nm nanocrystals with higher emitter or lower activator content, and imaged them at single-particle powers (FIG. 5). At lower powers (˜100 W/cm²), these new compositions have vanishingly low quantum yields (see Table 4), indicating that they would behave poorly in ensemble imaging experiments. But comparing β-NaYF₄ nanocrystals doped with 20% Yb³⁺ and 20% Er⁺³ (as well as 25% Gadolinium Gd³⁺ added to maintain β-phase morphology at high lanthanide doping levels) to conventional 8-nm UCNPs (β-NaYF₄ with 20% Yb³⁺ and 2% Er³⁺) dispersed on the same glass substrate, we observe that the conventional UCNPs are visible at lower powers, but the high-Er³⁺ UCNPs are not (FIG. 5a-d). As excitation powers are raised, the conventional UCNPs saturate in brightness while the high-Er³⁺ UCNPs become visible and continue to increase in brightness, surpassing the conventional UCNPs. The excitation intensity at which the 20% Er³⁺ UCNPs become brighter than their 2% Er³⁺ counterparts is at approximately 3×10⁵ W/cm² (FIG. 5a). The diverging brightness trends of these UCNPs, which agree well with simulated data (see FIG. 9), indicate one advantage of tailoring dopant compositions specifically for higher-flux imaging. This advantage is explicitly illustrated by simultaneously imaging the two classes of UCNPs at increasing excitation intensities, and also may be potentially useful in optical encoding applications or in conjunction with surface modifications that shift UCNP absorption or emission.

This strategy for increasing single nanocrystal brightness suggests that even smaller UCNPs may be viable as single-molecule probes. We tested this idea by synthesizing 5.5-nm diameter β-NaYF₄ UCNPs with 20% Er³⁺ and no Yb³⁺ sensitizer, as well as 4.8-nm UCNPs with ca. 20% each Er′, Yb³⁺ and 25% Gadolinium Gd³⁺ (FIG. 5e-f and Discussion). These nanocrystals are significantly smaller than other UCNPs imaged at the single particle level and are the approximate size of monomeric genetically encoded fluorescent proteins. We find that each of these compositions is significantly brighter than the canonical β-NaYF₄: 20% Yb³⁺ 2% Er³⁺ nanocrystals. We measured signals of ˜150 counts/second for single 4.8-nm UCNPs doped with 20% Yb³⁺ 20% Er³⁺ and note that these nanocrystals have QY<0.001% at lower excitation powers (Table 4). In comparison, we were unable to image single 5.5-nm β-NaYF₄: 20% Yb³⁺2% Er³⁺ nanocrystals because their signal falls below our sensitivity limit of −25 counts/second (see FIG. 5f and FIG. 7). The 4.8-nm UCNPs with 20% Yb³⁺ and 20% Er³⁺ are over 500-fold smaller in volume than nanocrystals optimized with higher emitter concentrations for single-particle excitation irradiance and imaged as single nanocrystals in suspension. These protein-sized nanocrystals have significant advantages over the larger UCNPs previously used in cellular imaging applications, including increased accessibility to small subcellular structures, greater tissue penetration, and reduced interference with biomolecule function, trafficking, and binding events.

FIG. 7 illustrates an experimental setup for single UCNP optical characterization. A 980 nm laser is prefocused with a 500 mm lens before entering the back aperture of a 0.95 NA 100× Objective (Zeiss), which adjusts the focal plane of the laser closer to that of the visible luminescence (dashed line). Emitted light is collected back through the same objective, filtered by two 700 nm short-pass (SP) filters and routed either to a LN-cooled CCD spectrometer (Princeton Instruments), or through two 532 nm long-pass (LP) filters (Chroma) to remove residual laser light and focused onto a single photon counting APD (MPD). For collecting data from just the green or red spectral band, a 540±20 nm (green) or 650±20 nm (red) band-pass (BP) filter was used in place of the 532 long-pass filters. A Time-Correlated Single Photon Counter (Picoquant) is used for luminescence lifetime measurements. All experiments were performed in ambient conditions at 10⁶/cm² unless otherwise noted. Power-dependent data and single particle line-cuts shown in FIG. 5 were collected with a 1.4 NA 100× oil immersion objective (Nikon).

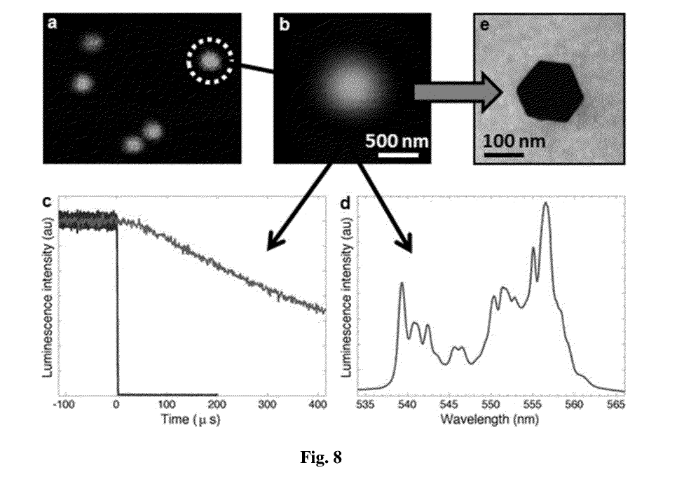

FIG. 8 illustrates data collection of single UCNP luminescence. FIG. 8a, confocal scans collected from UCNPs dispersed on TEM grids in ambient conditions. Isolated UCNPs are measured for FIG. 8b, luminescence intensity, FIG. 8c, lifetime decay and FIG. 8d, spectral emission. FIG. 8e, Individual UCNPs can confirmed by subsequent scanning transmission electron microscopy (STEM).

These new rules for designing small, bright UCNPs address key obstacles for optimizing nanocrystals as single-molecule probes and suggest a single-molecule probe development strategy involving iterative rounds of kinetic modeling and detailed nanocrystal characterization. We find that factors known to increase brightness at low powers are unimportant at single-molecule powers and that the brightest single-molecule probes may be non-luminescent at the ensemble level. For the most efficient nanocrystals, we find that 5-nm UCNPs are bright enough to be used in single-molecule detection. We anticipate further gains in brightness through iterative rounds of modeling and nanocrystal characterization, as well as surface modifications that alter the balance between various energy transfer pathways. Together, these advances open the door to a range of applications, including cellular and in vivo imaging, as well as reporting on local electromagnetic near-field properties of complex nanostructures.

### Methods Summary

β-NaYF₄: Yb³⁺, Er³⁺ nanocrystals were synthesized as reported and characterized by analytical TEM, DLS, and XRD. UCNPs were dispersed in hexane to approximately 0.1 nM before dropcasting onto silicon nitride TEM grids (Ted Pella, #21569-10). Laser scanning confocal imaging was performed in ambient conditions using a 980-nm continuous-wave laser (Thorlabs TCLDM9, 300 mW diode). (See below and FIG. 7 for instrument details). Because the diffraction-limited beam spot is larger than individual nanoparticle size, single particles were confirmed on SiN TEM-grid samples by subsequent SEM imaging (Zeiss Ultra-55, operating in transmission mode).

FIG. 10 illustrates an analysis of single UCNP luminescence intensity. Histograms of single particle luminescence intensity for UCNPs with diameters of FIG. 10a, 8 nm, FIG. 10b, 30 nm, FIG. 10c, 50 nm, and FIG. 10d, 150 nm. FIG. 10e, Single particle intensities plotted vs diameter (circles) and compared with the number of Er emitters in each particle (squares) as calculated from the particle volume and doping density (2%). Only intensities from single, non-aggregated nanocrystals, as determined by SEM-correlated intensity measurements, are used. Error bars (1 standard deviation; n˜60 per diameter) are smaller than symbols. Square line represents number of Er³⁺ emitters vs particle volume, circle line represents data fit to a model based on particles with non-luminescent surface regions of 1.7 nm. Excitation power was 10⁶ W/cm².

Single particle luminescence intensity histograms were compiled from approximately 50-300 individual particles for each size (see FIG. 10), and single particle spectra were obtained using the same confocal imaging system. To obtain lifetime data, a time-correlated-single-photon-counter (TCSPC, Picoquant) was used to tag photon arrival times of collected luminescence with respect to the laser operating in pulsed mode. The resulting time-resolved luminescence plots were fitted to a double exponential, since the nonradiative recombination rates from the surface and core regions of a UCNP are generally different²⁵. For clarity, only the dominant decay value was plotted in FIG. 3 (see FIGS. 12-13 for more complete information).

In our optical setup, the excitation laser was pre-focused with a 500 mm lens before entering the back aperture of either a 0.95 NA 100× air objective (used for the data in FIGS. 2 and 3) or a 1.4 NA 100× oil objective (FIG. 5). Emitted light was collected with the same objective and filtered by two 700-nm short-pass filters (Chroma) to remove residual laser light. Emission was then routed either through a spectrometer, or through additional 532 long-pass filters and onto a single photon counting avalanche photodiode (APD). For collecting data from just the green or red spectral band, a 540±20 nm (green) or 650±20 nm (red) band-pass (BP) filter was used in place of the 532 long-pass filters. A Time-Correlated Single Photon Counter (Picoquant) was used for luminescence lifetime measurements.

Single particle imaging shown in FIG. 5 was performed using a 1.4 NA, 100× oil-immersion objective. Equal dilutions of 20%/2% (Yb/Er) and 25%/20%/20% (Gd/Yb/Er) UCNPs were dropcast onto a glass coverslip and imaged at various powers. For mixtures of nanocrystals with differing dopant compositions, compositions were identified by comparison with optical behaviors of each composition imaged individually (FIG. 5d). Single particle, power-dependent plots were constructed by scanning the laser beam over an isolated particle and dividing the collected luminescence curve by the laser beamspot profile, assuming Gaussian shapes. Consecutive linecut scans at increasing excitation powers were compiled to produce the plots shown in FIG. 5a. Linecuts shown in FIG. 5e-f were collected from single particles at a fixed excitation power of 3×10⁶ W/cm².

### Supplemental Methods: Quantum Yields

Method for determining upconversion luminescence quantum yields. For determination of upconversion luminescence quantum yields, the UCNP dispersions in hexane (500 μL) were placed in a quartz sample holder, which was inserted into an integrating sphere (Horiba Jobin-Yvon) for the Fluorolog-3 spectrometer. The light paths between the excitation laser (Sheaumann, 976 nm, 1 W), integrating sphere, and the spectrometer were routed using fiber optic bundles (Fiberoptic Systems, Inc). For each sample, the emission was measured from 490 to 710 nm. The spectrum of the excitation radiation not absorbed by the sample (the “excitation spectrum”) was measured at the detector from 970 to 990 nm through a neutral density filter. Pure hexane was used to record blank excitation and emission spectra. Excitation and emission spectra were corrected for the sensitivity of the detector over the appropriate wavelengths using a NIST-traceable calibrated light source (Avantes Avalight HAL-CAL) with the same integrating sphere, fiber optic setup, detector, and spectrometer settings. Excitation spectra were also corrected using the transmission spectrum of the neutral density filter.

The absolute quantum yield (QY) of each sample was then determined according to the equation:

$$Φ = \begin{matrix}\text{?} \\ \text{?}\end{matrix}$$

$$\text{?} \text{indicates text missing or illegible when filed}$$

where Iₑₘ indicates the integrated intensity over the wavelength range of the peak of interest and Iₑₓ is the integrated intensity of the unabsorbed excitation radiation from 970 to 990 nm.

TABLE 4
Experimental and simulated quantum yields

| Sample | | | |
|---|---|---|---|
| Diameter | Composition | Quantum Yield (%) @ 100 W/cm² | |
| (nm) | (Yb/Er/[Gd] %) | Experiment* | Simulation. |
| 5 | 20/2 | 2.2 · 10⁻³ | 2.9 · 10⁻³ |
| 5 | 20/20/25 | 7.2 · 10⁻⁴ | 1.2 · 10⁻³ |
| 5 | 0/20 | 1.2 · 10⁻² | 3.2 · 10⁻⁵ |
| 8 | 20/2 | 1.1 · 10⁻² | 7.2 · 10⁻³ |
| 8 | 20/20/25 | 6.3 · 10⁻⁴ | 3.1 · 10⁻³ |
| 8 | 2/20 | 1.5 · 10⁻² | 3.2 · 10⁻⁴ |
| 8 | | | |
| +3 nm | 20/2 | 0.49 | 1.5 |
| shell | | | |

*Quantum yield experimental errors are estimated to be ±50% relative error.

FIG. 11 illustrates anti-bunching measurement on single particles. FIG. 11a, Experimental setup showing Hanbury-Brown Twiss arrangement with two single-photon counting APDs. FIG. 11b, Plot of coincidences vs time between measured photons for a single quantum dot. Bin-time was 2 ns. Plot was shifted 50 ns to show the dip in coincidences that denotes the presence of a single two-level emitter. FIG. 11c, Plot of coincidences vs time between measured photons for a single 8-nm UCNP. Bin-time was 250 ns. Absence of a dip in coincidences above the RMS noise level (approx. 10%) suggests the 8 nm UCNP has >10 emitters.

FIG. 12 illustrates luminescent decay data from a 150 nm UCNP at 10⁴ W/cm² excitation intensity and subsequent fitting. Here, all wavelengths in the range of 532 nm-700 nm were collected by the avalanche photodiode.

FIG. 13 illustrates a comparison of the major lifetime component values for green band (G curve) (540±20 nm), red band (R curve) (650±20 nm), and “all” wavelength range (A curve) (532 nm-700 nm) luminescence. Here, the major lifetime component value is defined as the lifetime value corresponding to the larger of the two fitting coefficients (the larger of A₁ and A₂; see FIG. 12 for fitting parameter definitions) in the bi-exponential fit. Lifetimes are plotted as a function of the excitation intensity (log scale), for a 150 nm UCNP. We observe that all lifetime values decrease with increasing pump intensity for UCNPs of this size. Contrast this with the lifetimes measured for the sub-10 nm UCNPs, in which lifetime is found to remain the same at all pump intensities measured (see FIG. 3). Note that lifetimes are single-exponential for the sub-10 nm particles.

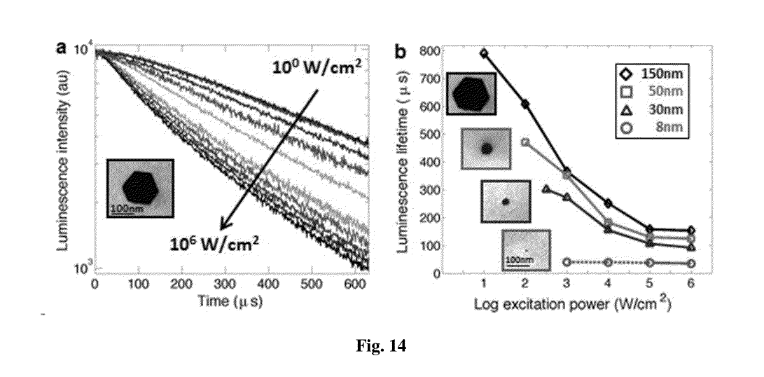

FIG. 14 illustrates single particle lifetime vs excitation power. FIG. 14a, luminescence decay curves from a single 150 nm UCNP as the excitation power was varied from 1 W/cm² to 10⁶ W/cm². FIG. 14b, single UCNP lifetime values for various particle diameters plotted as a function of excitation power. For simplicity only dominant lifetime decay values are plotted. Dashed line represents data collected from 8 nm UCNP clusters.

FIG. 15 illustrates luminescence decay curves vs nanocrystal diameter. FIG. 15a-d, Luminescence decay curves for single UCNPs with diameters of 150, 50, 30, and 8 nm, respectively. Insets: STEM images of single UCNPs.

FIG. 16 illustrates single particle luminescence of core-shell UCNPs. STEM images, diameter histograms and single-particle intensity histograms for 8 nm UCNPs with undoped NaYF₄ shell thicknesses of FIG. 16a, 0 nm, FIG. 16b, 0.5 nm, FIG. 16c, 1.4 nm, FIG. 16d, 1.8 nm, and FIG. 16e, 2.5 nm. Scale bar: 10 nm. Shell thicknesses were determined by subtracting the average equivalent diameters of the shelled and core particles, where the equivalent diameter is the diameter of a circle with the same area as the STEM projection of a nanoparticle. FIG. 16f, single particle intensity and FIG. 16g, luminescence lifetime plotted vs shell thickness. We note that we are only collecting emission in the spectral band between 532 nm and 700 nm, so any shell-related increase in emission for wavelengths shorter than 532 is not captured here. Error bars represent one standard deviation.

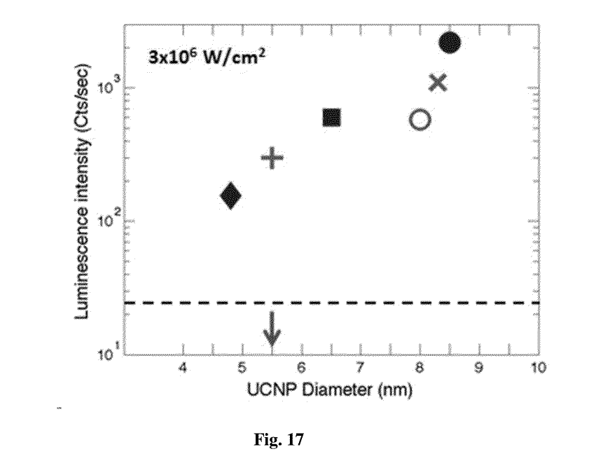

FIG. 17 illustrates single particle intensities for sub-10 nm UCNPs with various dopant compositions. The dot, square, and diamond are 25% Gd³⁺, 20% Er³⁺, 20% Yb³⁺ composition particles. Gadolinium Gd³⁺ was added to maintain β-phase crystal structure while increasing Er³⁺ and Yb³⁺ percentage. The cross (x) and plus-sign (+) are 20% Er³⁺, 0% Yb³⁺ composition, The circle is 2% Er³⁺, 20% Yb³⁺ composition. The arrow denotes a 2% Er³⁺, 20% Yb³⁺ 5.5 nm particle that fell below the detector sensitivity of 25 cts (dashed line). Excitation power was 3×10⁶ W/cm².

FIG. 18 illustrates representative mechanism output from simulations. Performed for 8-nm diameter, 20% Yb³⁺, 2% Er³⁺:NaYF₄ UCNPs excited at 976 nm (10⁴ W/cm²). Arrows correspond to electric dipole absorption or emission (R arrows), magnetic dipole absorption or emission (G arrows), and multi-phonon relaxation (Gr arrows). Energy transfer processes (B arrows) are represented by pairs of arrows with the same number label (text in squares). The thickness of arrows increases logarithmically with the rate of the transition (see legend), with the maximum and minimum thicknesses set by the user. Transitions with rates higher than the maximum thickness threshold have the maximum thickness, while transitions with rates lower than the minimum thickness threshold are not shown. Non-radiative transitions are further filtered by their relative contributions according the path tracing methods described in Chan et al.

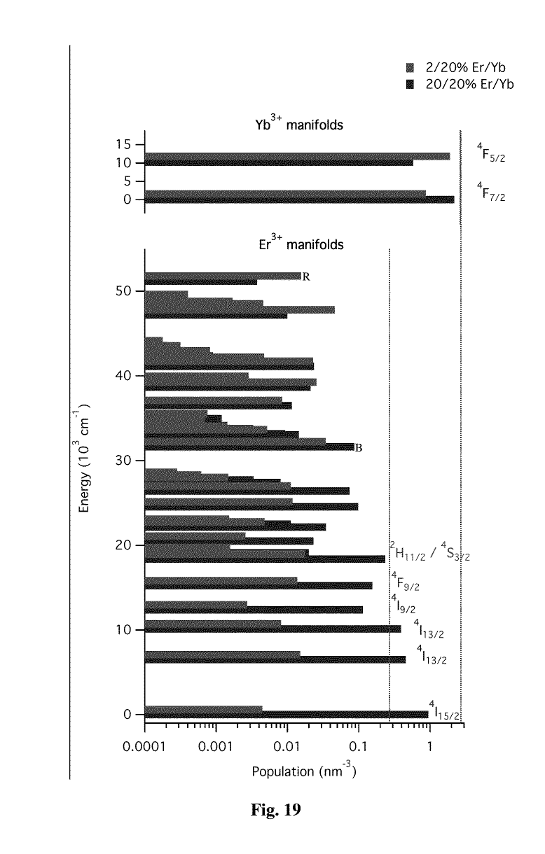

FIG. 19 illustrates steady-state manifold populations for Yb³⁺ and Er³⁺ from simulations of 8-nm UCNPs with 20% Er³⁺ (B bars) and 2% Er³⁺ (R bars), each with 20% Yb³⁺, at 10⁶ W/cm² excitation. Dotted lines indicate the total ion concentration (e.g., 2.76 ions/nm⁻³ for 20% Er³⁺).

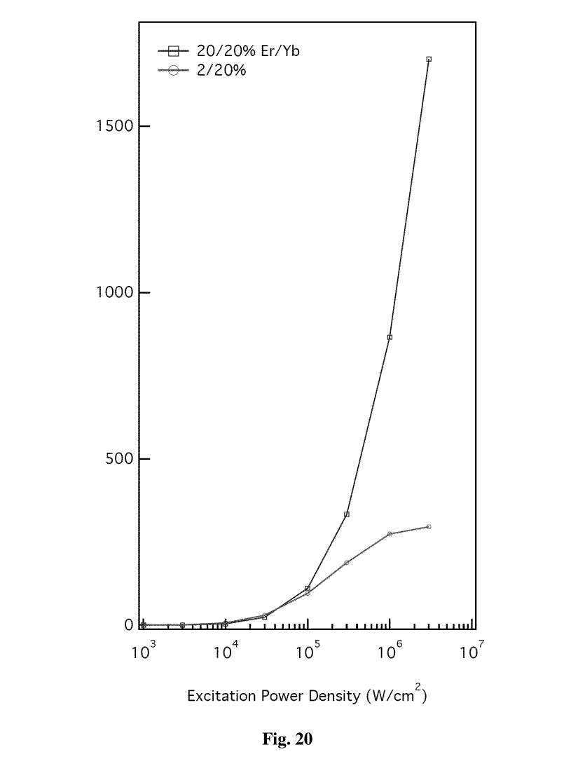

FIG. 20 illustrates simulated luminescence intensity of 8-nm UCNPs with 20% (square curve) and 2% (circle curve) Er³⁺, each with 20% Yb³⁺, plotted as functions of excitation power.

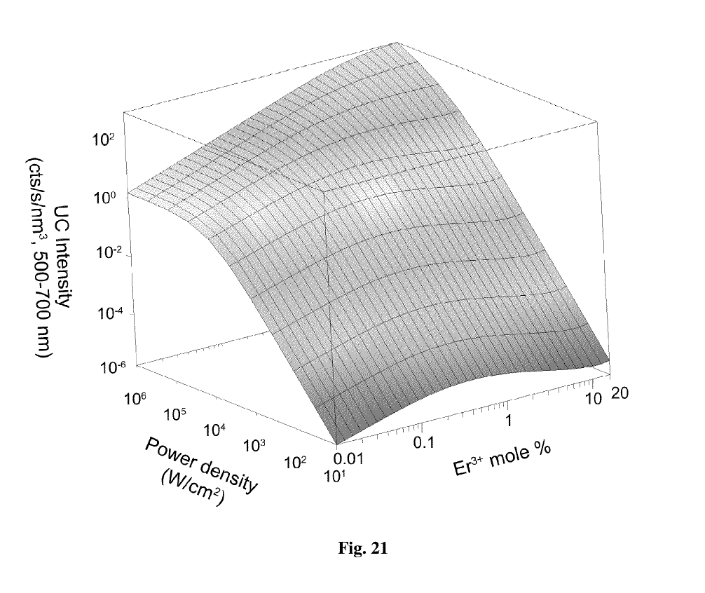

FIG. 21 illustrates simulated luminescence intensity of 8 nm UCNPs with 20% Yb³⁺ as a function of Er³⁺ doping and excitation power at 976 nm.

What is claimed is:

1. A phosphorescent upconverting sub-10 nm nanoparticle comprising:
a lanthanide-doped hexagonal β-phase sodium yttrium fluoride NaYF₄ nanocrystal.

2. The phosphorescent upconverting nanoparticle of claim 1, wherein the hexagonal β-phase NaYF₄ nanocrystal comprises a 1:1:4 stoichiometry of Na⁺, Y³⁺, and F⁻, respectively.

3. The phosphorescent upconverting nanoparticle of claim 1, wherein the nanoparticle is an Erbium Er³⁺, Ytterbium Yb³⁺ lanthanide-doped hexagonal β-phase NaYF₄:Er³⁺/Yb³⁺ nanocrystal.

4. The phosphorescent upconverting nanoparticle of claim 3, wherein the nanoparticle is a 20% Er³⁺, 20% Yb³⁺ lanthanide-doped hexagonal β-phase NaYF₄:Er³⁺/Yb³⁺ nanocrystal.

5. The phosphorescent upconverting nanoparticle of claim 3, wherein the sub-10 nm nanoparticle has a lattice spacing of approximately 3.5 Å.

6. The phosphorescent upconverting nanoparticle of claim 3, wherein the sub-10 nm nanoparticle has an average diameter of 5.4±0.6 nm.

7. The phosphorescent upconverting nanoparticle of claim 1, wherein the hexagonal β-phase NaYF₄ nanocrystal comprises a core/shell heterostructure with a NaYF₄ shell

8. The phosphorescent upconverting nanoparticle of claim 7, wherein the hexagonal β-phase NaYF₄ nanocrystal comprises a core/shell heterostructure with an approximately <2 nm thick NaYF₄ shell.

9. The phosphorescent upconverting nanoparticle of claim 7, wherein the hexagonal β-phase NaYF₄ nanocrystal comprises β-NaYF₄:Er³⁺/Yb³⁺, 2% Er³⁺, 20% Yb³⁺ and a NaYF₄ core/shell heterostructure.

10. The phosphorescent upconverting nanoparticle of claim 7, wherein the hexagonal β-phase NaYF₄ nanocrystal comprises β-NaYF₄:Er³⁺/Yb³⁺, 20% Er³⁺, 20% Yb³⁺ and a NaYF₄ core/shell heterostructure.

11. The phosphorescent upconverting nanoparticle of claim 1, wherein the nanoparticle is a 1% to 30% Er³⁺, 0% to 30% Yb³⁺ lanthanide-doped hexagonal β-phase NaYF₄:Er³⁺/Yb³⁺ nanocrystal.

12. The phosphorescent upconverting nanoparticle of claim 1, wherein the nanoparticle is a 1% to 30% Er³⁺, 0% to 30% Yb³⁺ lanthanide-doped hexagonal β-phase NaYF₄:Er³⁺/Yb³⁺ nanocrystal.

13. The phosphorescent upconverting nanoparticle of claim 1, wherein the nanoparticle is a 1% to 30% Er³⁺, 0% to 30% Yb³⁺, 0% to 30% Gadolinium Gd³⁺ lanthanide-doped hexagonal β-phase NaYF₄:Er³⁺/Yb³⁺ nanocrystal.

14. A method of imaging a phosphorescent upconverting sub-10 nm lanthanide-doped hexagonal β-phase sodium yttrium fluoride NaYF₄:Er³⁺/Yb³ nanocrystal comprising:
illuminating the single upconverting sub-10 nm lanthanide-doped hexagonal β-phase sodium yttrium fluoride NaYF₄:Er³⁺/Yb³ nanocrystal with a 980 nanometer laser beam with an optical power greater than approximately 3×10⁵ W/cm²; and
measuring a shorter wavelength light emitted by the single upconverting sub-10 nm lanthanide-doped hexagonal β-phase sodium yttrium fluoride NaYF₄:Er³⁺/Yb³ nanocrystal.
